(19) United States
(12) Patent Application Publication
(10) Pub. No.: US 2025/0253960 A1
(43) Pub. Date: Aug. 7, 2025

(54) SYSTEMS AND METHODS FOR CALIBRATION OF TRANSMIT CHAINS IN A BASE STATION

(71) Applicant: HFCL Limited, Bangalore (IN)

(72) Inventors: Parag AGGARWAL, Bangalore (IN); Subhas Chandra MONDAL, Bangalore (IN)

(73) Assignee: HFCL Limited, Bangalore (IN)

(21) Appl. No.: 19/045,533

(22) Filed: Feb. 4, 2025

(30) Foreign Application Priority Data
Feb. 5, 2024 (IN) 202441007769

(51) Int. Cl. H04B 17/11; H04B 7/08

(52) U.S. Cl. CPC H04B 17/11; H04B 7/0868

(57) ABSTRACT

Systems and methods for antenna calibration of transmit chains in a base station are described. In particular, the method includes determining, by a controller, that user data transmission is initiated in an operating phase of the base station. A need for calibration of a plurality of transmit chains in the base station is determined. In response to the determination, the method includes detecting an arrival of at least one of a guard period of a special time slot in a Time-Division Duplex (TDD) radio frame, and an Orthogonal Frequency-Division Multiplexing (OFDM) symbol allocated by one or more higher layers in a Frequency Division Duplex (FDD) radio frame. The method includes performing fine-tuned calibration of each of the plurality of transmit chains based on the detection.

### TECHNICAL FIELD

The present disclosure, in general, relates to managing calibration of radio frequency (RF) components in a wireless communication network, and in particular, relates to systems and methods for calibration of transmit chains in a wireless communication device, for example, a base station.

### BACKGROUND

A fifth-generation (5G) new radio (NR) base station (BS) supports high peak data rates with better reliability to multiple users simultaneously in a larger coverage area. The key enabler for such support is massive multiple-input-multiple-output (MIMO) technology. It provides several techniques to boost the performance of the BS, such as spatial diversity to enhance transmission robustness, spatial multiplexing to improve the peak data rates, and beamforming to increase signal-to-noise ratio (SNR). To get full advantages of MIMO techniques, the radio paths should have identical characteristics, such as having same gain and phase responses with same group delay. However, the actual radio paths have different characteristics due to different components and radio frequency (RF) paths. The characteristics of the radio path may also be affected by temperature variations during actual data transmission. Thus, calibration of the radio paths is required to ensure consistent MIMO performance.

For antenna calibration, usually time-frequency resources are reserved by higher layers and user data transmission on the reserved resources is halted during the calibration process. This reduces spectrum efficiency of the BS, especially when the calibration is set to repeat periodically. Hence, there is a need for a system and a method to maintain high spectrum efficiency without disturbing the user data transmission during the calibration. During an operating phase or data transmission, the BS may implement the antenna calibration from time to time to check an integrity of estimated calibration coefficients. This repetition may be referred to as calibration periodicity. Generally, the calibration is set to repeat after regular intervals, referred to as periodic calibration. The periodic calibration with lower periodicity may increase the processing overhead of a system, while higher periodicity may reduce effectiveness of the calibration process.

FIGS. 1A-1C illustrate system architecture for antenna calibration.

FIG. 1A depicts an ideal scenario where all transmit chains have similar characteristics. FIG. 1B depicts a base station with no calibration logic. FIG. 1C depicts the base station with an internal antenna calibration block.

Antenna calibration requires a loopback mechanism, which may be over-the-air (OTA) or an internal dedicated feedback path. OTA calibration may require a receiver or a user equipment (UE) which may not be available during the calibration, especially in a start-up/bootup phase of the BS. Moreover, the OTA calibration requires receive chains to capture the signal used for calibration of the transmit chains. If the receive chains are not calibrated, then precise transmit chain calibration may not be implemented. Moreover, a hardware design of the transmit and receive chains may not be symmetrical, which may also lead to non-optimal calibration. While the calibration with the internal dedicated feedback path does not suffer from such issues, it requires additional resources whose functionalities again need to be optimized for enhanced performance.

The existing systems do not offer any efficient mechanism for antenna calibration of the 5G NR MIMO BS with low processing complexity while maintaining spectrum efficiency. Therefore, there is, a need for a system and a method to calibrate the RF paths at a start-up phase and during an operating phase of the 5G NR MIMO BS adaptively without impacting user data transmission.

### OBJECTS OF THE PRESENT DISCLOSURE

It is an object of the present disclosure to provide a system and a method to calibrate Radio Frequency (RF) paths at a start-up phase and during an operating phase of a fifth-generation (5G) new radio (NR) base station (BS) adaptively without impacting user data transmission.

It is an object of the present disclosure to provide a system and a method to calibrate RF transmission paths during run-time of a communication apparatus, i.e., calibration of RF transmission path in between data transmission without affecting a data transmission rate.

It is an object of the present disclosure to provide a system and a method for handling variation in temperature and processing delay between multiple RF transmission paths.

It is an object of the present disclosure to provide a system and a method to adaptively calibrate RF transmit chains in a multiple-input-multiple-output (MIMO) communication apparatus which also utilizes resources optimally and effectively.

### SUMMARY

In an aspect, the present disclosure relates to a method for calibration of transmit chains in a start phase of a base station. The method includes setting, by a controller, delay values to zero and calibration coefficients to unity with zero phase for each of a plurality of transmit chains. The method includes setting, by the controller, a first multiplexer to send orthogonal sequences on each of the plurality of transmit chains. The method includes obtaining, by the controller, a first summed signal of the plurality of transmit chains. The method includes estimating, by the controller, a first response and a first time delay for each of the plurality of transmit chains by cross-correlating the first summed signal with an orthogonal sequence. The method includes computing, by the controller, calibration coefficients and delay values for each of the plurality of transmit chains based on the estimated first response to mitigate relative gain and phase differences with respect to a given transmit chain.

In an embodiment, the method may include setting, by the controller, a second multiplexer to send frequency domain equivalent of the orthogonal sequences on each of the plurality of transmit chains. The method may include applying, by the controller, the computed calibration coefficients on the frequency domain equivalent of the orthogonal sequences to obtain calibrated sequences. The method may include performing, by the controller, Orthogonal Frequency-Division Multiplexing (OFDM) modulation on the calibrated sequences. The method may include controlling, by the controller, the first time delay in each of the plurality of transmit chains by adjusting a timing of the calibrated sequences.

In an embodiment, the method may include setting, by the controller, the first multiplexer to send the calibrated sequences on each of the plurality of transmit chains. The method may include obtaining, by the controller, a second summed signal of the plurality of transmit chains. The method may include estimating, by the controller, a second response and a second time delay for each of the plurality of transmit chains. The method may include computing, by the controller, a gain difference, a phase difference, and a timing delay difference of each of the plurality of transmit chains with respect to the given transmit chain, based on the estimation. The method may include comparing, by the controller, the gain difference, the phase difference, and the timing delay difference of each of the plurality of transmit chains with a gain error threshold, a phase error threshold, and a delay error threshold, respectively.

In an embodiment, responsive to at least one of the gain difference, the phase difference, and the timing delay difference of each of the plurality of transmit chains being less than the gain error threshold, the phase error threshold, and the delay error threshold, respectively, the method may include storing, by the controller, the computed calibration coefficients and the delay values in a database associated with the base station to perform calibration of the plurality of transmit chains.

In an embodiment, responsive to at least one of the gain difference, the phase difference, and the timing delay difference of each of the plurality of transmit chains being greater than the gain error threshold, the phase error threshold, and the delay error threshold, respectively, the method may include computing, by the controller, updated calibration coefficients and/or updated delay values for each of the plurality of transmit chains based on the estimated response to mitigate the gain difference, the phase difference, or the timing delay difference with respect to the given transmit chain.

In an aspect, the present disclosure relates to a method for calibration of transmit chains in a base station. The method includes determining, by a controller, that user data transmission is initiated in an operating phase of the base station. The method includes determining, by the controller, a need for calibration of a plurality of transmit chains in the base station. In response to the determination, detecting, by the controller, an arrival of at least one of: a guard period of a special time slot in a Time-Division Duplex (TDD) radio frame, or an Orthogonal Frequency-Division Multiplexing (OFDM) symbol allocated by one or more higher layers in a Frequency Division Duplex (FDD) radio frame. The method includes performing, by the controller, fine-tuned calibration of each of the plurality of transmit chains based on the detection.

In an embodiment, determining, by the controller, the need for the calibration of the plurality of transmit chains may be based on at least one of: an expiry of a timer, a request by the one or more higher layers, an event of a change in temperature, and a fault being identified in a given transmit chain of the plurality of transmit chains.

In an embodiment, performing, by the controller, the fine-tuned calibration of each of the plurality of transmit chains may include, for each of the plurality of transmit chains, setting, by the controller, a first multiplexer to send orthogonal sequences on the plurality of transmit chains. The method may include applying, by the controller, calibration coefficients on the orthogonal sequences to obtain calibrated sequences, where the calibration coefficients are computed during a start phase of the base station or during earlier stages of the operating phase. The method may include performing, by the controller, OFDM modulation on the calibrated sequences, The method may include controlling, by the controller, a delay in each of the plurality of transmit chains by adjusting a timing of the calibrated sequences.

In an embodiment, the method may include setting, by the controller, a second multiplexer to send the calibrated sequences on the plurality of transmit chains. The method may include obtaining, by the controller, a summed signal of the plurality of transmit chains. The method may include estimating, by the controller, a response and a time delay of each of the plurality of transmit chains by cross-correlating the summed signal of the plurality of transmit chains with an orthogonal sequence. The method may include computing, by the controller, a gain difference, a phase difference, and a timing delay difference of each of the plurality of transmit chains with respect to a given transmit chain, based on the estimation. The method may include comparing, by the controller, the gain difference, the phase difference, and the timing delay difference of each of the plurality of transmit chains with a gain error threshold, a phase error threshold, and a delay error threshold, respectively.

In an embodiment, responsive to at least one of the gain difference, the phase difference, and the timing delay difference of each of the plurality of transmit chains being less than the gain error threshold, the phase error threshold, and the delay error threshold, respectively, the method may include storing, by the controller, the calibration coefficients in a database associated with the base station to perform the fine-tuned calibration of each of the plurality of transmit chains.

In an embodiment, responsive to at least one of the gain difference, the phase difference, and the timing delay difference of each of the plurality of transmit chains being greater than the gain error threshold, the phase error threshold, and the delay error threshold, respectively, the method may include computing, by the controller, updated calibration coefficients for each of the plurality of transmit chains based on the estimated response. The method may include detecting, by the controller, an arrival of at least one of: a guard period of a consecutive special time slot in the TDD radio frame, or an OFDM symbol allocated by the one or more higher layers in the FDD radio frame. The method may include performing, by the controller, the fine-tuned calibration of each of the plurality of transmit chains based on the detection.

In an embodiment, the guard period may correspond to a first guard period of the special time slot.

In an embodiment, the fine-tuned calibration may include at least an adaptive calibration, and for the adaptive calibration, the method may include adaptively controlling, by the controller, a value of the timer for performing the fine-tuned calibration of the plurality of transmit chains.

In an aspect, the present disclosure relates to a base station for calibration of transmit chains in a start phase. The base station includes a controller associated with a processor, and a memory operatively coupled to the processor. The memory includes processor-executable instructions which, when executed by the processor, cause the controller to set delay values to zero and calibration coefficients to unity with zero phase for each of a plurality of transmit chains. The controller sets a first multiplexer to send orthogonal signal sequences on each of the plurality of transmit chain. The controller obtains a first summed signal of the plurality of transmit chains. The controller estimates a first response and a first time delay for each of the plurality of transmit chains by cross-correlating the first summed signal with an orthogonal sequence. The controller computes calibration coefficients for each of the plurality of transmit chains based on the estimated first response to mitigate relative gain and phase differences with respect to a given transmit chain.

In an aspect, the present disclosure relates to a base station for calibration of transmit chains in an operating phase. The base station includes a controller associated with a processor, and a memory operatively coupled to the processor. The memory includes processor-executable instructions which, when executed by the processor, cause the controller to determine that user data transmission is initiated in the operating phase of the base station, and determine a need for calibration of a plurality of transmit chains in the base station. In response to the determination, the controller detects an arrival of at least one of a guard period of a special time slot in a Time-Division Duplex (TDD) radio frame, and an Orthogonal Frequency-Division Multiplexing (OFDM) symbol allocated by one or more higher layers in a Frequency Division Duplex (FDD) radio frame, and perform fine-tuned calibration of each of the plurality of transmit chains based on the detection.

In an embodiment, the controller may perform the fine-tuned calibration of each of the plurality of transmit chains by being configured to combine signals of each of the plurality of transmit chains, and estimate a response and a time delay for each of the plurality of transmit chains.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIGS. 1A-1C illustrate conventional system architecture for antenna calibration in a 5th Generation (5G) Multiple Input Multiple Output (MIMO) base station.

FIG. 2 illustrates an exemplary system architecture for antenna calibration with a calibration port inside an antenna panel, in accordance with an embodiment of the present disclosure.

FIG. 3 illustrates an exemplary system architecture for antenna calibration with no calibration port inside an antenna panel, in accordance with an embodiment of the present disclosure.

FIG. 4A illustrates an exemplary representation of a 5G New Radio (NR) Time Division Duplex (TDD) radio frame, in accordance with an embodiment of the present disclosure.

FIG. 4B illustrates an exemplary representation for implementing calibration in a special slot with two guard periods, in accordance with an embodiment of the present disclosure.

FIG. 4C illustrates an exemplary representation for implementing calibration in a special slot with four guard periods, in accordance with an embodiment of the present disclosure.

FIG. 5 illustrates a high-level flow chart of an exemplary method for antenna calibration of transmit chains, in accordance with an embodiment of the present disclosure.

FIG. 6 illustrates a flow chart of an exemplary method for coarse calibration of transmit chains during a start-up phase of a base station, in accordance with an embodiment of the present disclosure.

FIG. 7 illustrates an exemplary representation of ZadoffChu sequences for different transmit chains in a base station, in accordance with an embodiment of the present disclosure.

FIG. 8 illustrates a flow chart of an exemplary method for implementing fine-tuned calibration of transmit chains during an operating phase of a base station, in accordance with an embodiment of the present disclosure.

FIG. 9 illustrates an exemplary representation of fine-tuned calibration in two special slots, in accordance with an embodiment of the present disclosure.

FIG. 10A illustrates an exemplary representation of a gain plot of an estimated value of transmit chain responses before calibration, in accordance with an embodiment of the present disclosure.

FIG. 10B illustrates an exemplary representation of a gain plot of an estimated value of transmit chain responses after calibration, in accordance with an embodiment of the present disclosure.

FIGS. 11A and 11B illustrate exemplary representations of a gain plot of signal at different antenna ports without antenna calibration, in accordance with an embodiment of the present disclosure.

FIGS. 12A and 12B illustrate exemplary representations of a gain plot of signal at different antenna ports with antenna calibration, in accordance with an embodiment of the present disclosure.

FIGS. 13A and 13B illustrate exemplary representations of a phase plot of signal at different antenna ports without antenna calibration, in accordance with an embodiment of the present disclosure.

FIGS. 14A and 14B illustrate exemplary representations of a phase plot of signal at different antenna ports with antenna calibration, in accordance with an embodiment of the present disclosure.

FIG. 15 illustrates an exemplary computer system in which or with which embodiments of the present disclosure may be implemented.

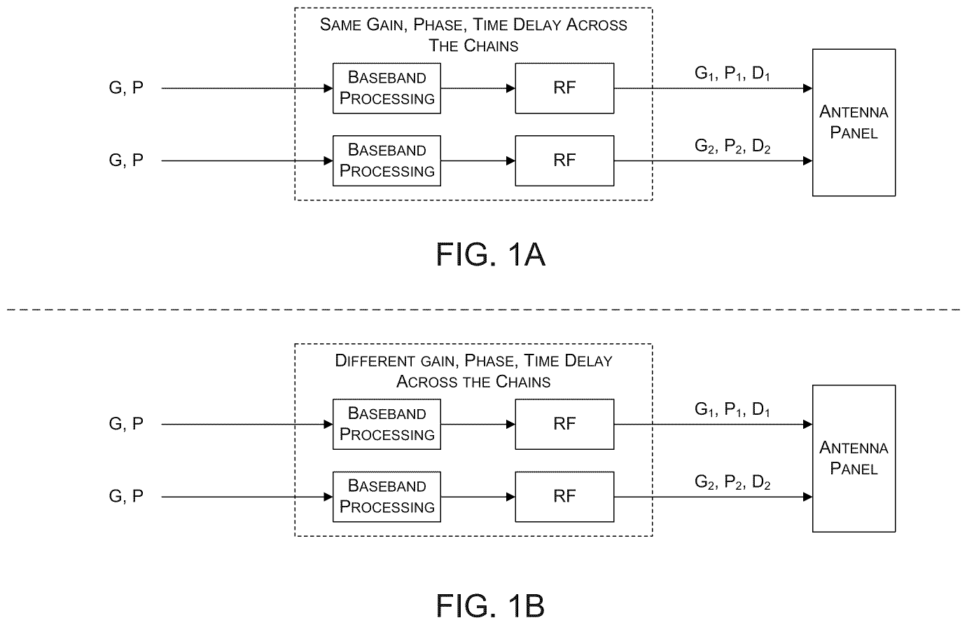

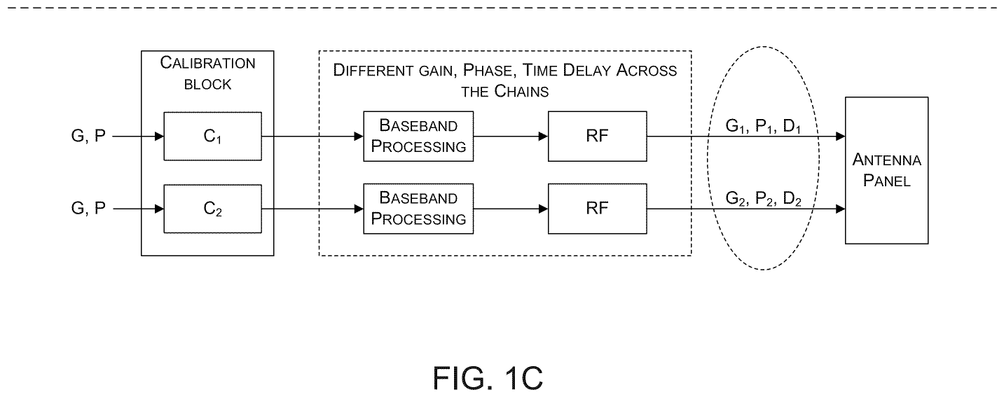

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

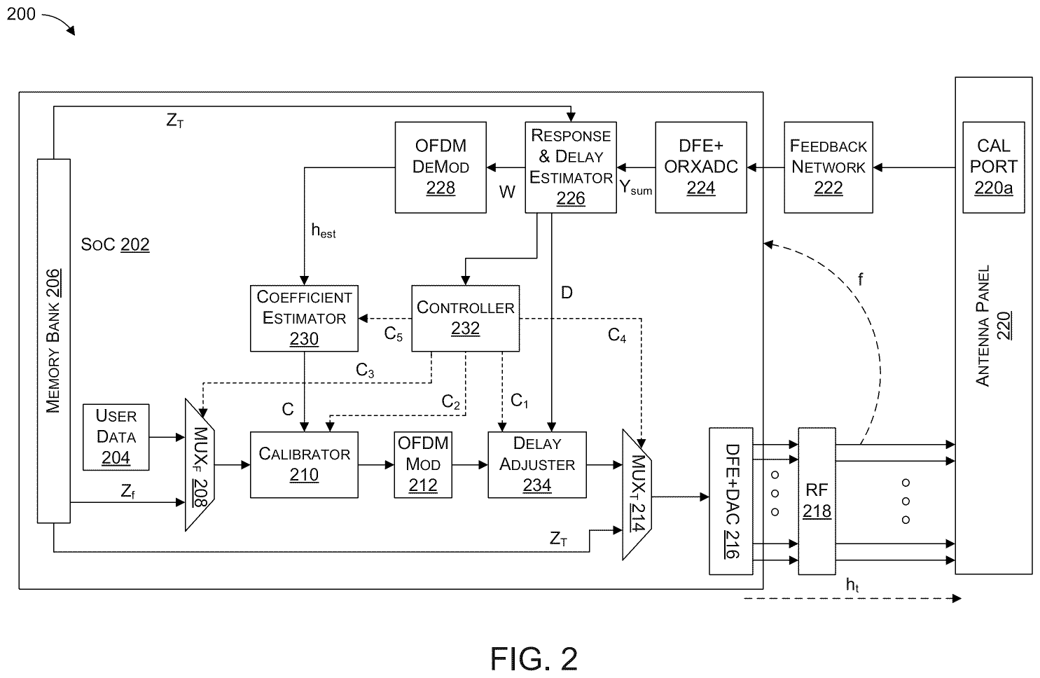

The various embodiments throughout the disclosure will be explained in more detail with reference to FIGS. 2-15.

FIG. 2 illustrates an exemplary system architecture (200) for antenna calibration with a calibration port (220a) inside an antenna panel (220), in accordance with an embodiment of the present disclosure.

In particular, the exemplary system architecture (200) may represent a communication system such as a 5th Generation (5G) or next-generation communications system (200). As depicted, the architecture (200) includes different antenna panels (220) in which an in-built calibration port (220a) is provided. The calibration port (220a) may provide a summed output of small portion of signals coming inside the antenna panels (220) or Radio Frequency (RF) antenna ports of the antenna panel (220). The system architecture (200) may be utilized in both types of base stations, which have antenna panels (220) with and without in-built calibration ports (220a).

In an embodiment, the system architecture (200) may include a System on Chip (SoC) (202). The SoC (202) may include a processing system (or interchangeably referred to as a processor) and a programming logic for baseband processing of incoming data and other control functions.

In an embodiment, user data (204) may be in the form of a frequency domain modulated in-phase (I) and quadrature (Q) symbols from higher layers of the base station. The higher layers may be a high Physical (PHY) layer including, but not limited to, Media Access Control (MAC) and Radio Link Control (RLC) layers.

In an embodiment, a memory bank (206) may include orthogonal sequences with its circularly shifted sequences on a time domain (Zr) and their frequency domain equivalent (Z_{F}) for calibration coefficients.

In an embodiment, a second multiplexer (MUX_{F}) (208) may switch between the user data (204) and the orthogonal sequence from the local memory bank (206) in the frequency domain. Examples of the orthogonal sequences may include, but not limited to, Constant Amplitude Zero Auto-Corelation waveform (CAZAC) signal, ZadoffChu sequence (Z), Walsh-Hadamard code, etc.

In an embodiment, a calibrator (210) may contain complex multipliers to multiply the frequency domain data with calibration coefficients to compensate for gain, phase, and timing differences with respect to a reference chain.

In an embodiment, an Orthogonal Frequency Division Multiplexing (OFDM) modulator (212) may perform inverse Fast Fourier transform (iFFT) and cyclic prefix addition operations.

In an embodiment, a delay adjuster (234) may delay time domain data with estimated delay values to compensate for the timing differences with respect to the reference chain.

In an embodiment, a first multiplexer (MUX_{T}) (214) may switch between the calibrated data and the orthogonal sequence (Z_{T}) from the local memory bank (206) in the time domain.

In an embodiment, a Digital Front End (DFE) and a digital to analog converter (DAC) (216) may pre-distort and upconvert the incoming time-domain IQ symbols and then convert them to an analog domain.

In an embodiment, Radio Frequency (RF) module (218) may process the signal with a series of RF components. The RF module (218) may amplify the signal with the series of RF components with a desired output power before transmission.

In an embodiment, the antenna panel (220) may radiate the RF signals for transmission. As discussed herein, the antenna panel (220) may include the in-built calibration port (220a), which provides a summed output of a portion of the signal input to all RF antenna ports.

In an embodiment, a feedback network (222) may include a series of attenuators to keep the power level of the feedback signal in an operating range of an observation (ORX) analog to digital converter (ADC) (224).

In an embodiment, a DFE and ORX-ADC (224) may convert the analog signal to a digital signal and then down-convert the digital signal.

In an embodiment, a response and delay estimator (226) may estimate the response and time delay of all transmit chains.

In an embodiment, an OFDM demodulator (228) may perform cyclic prefix removal and Fast Fourier Transform (FFT) operations.

In an embodiment, a coefficient estimator (230) may estimate the calibration coefficients for antenna calibration based on the estimated response and time delay of all transmit chains.

In an embodiment, a controller (232) may control the whole operation of the antenna calibration. During a start-up phase, the controller (232) may initially identify a control signal (c₁) to reset the calibration coefficients. The controller (232) may identify the control signal (c₁) to update the coefficients with their estimated value during the rest of the start-up phase and the operating phase. The controller (232) may identify the control signals, c₂ and c₃ to control the first multiplexer (MUX_{T}) (214) and the second multiplexer (MUX_{F}) (208), respectively.

The controller (232) may take an input from the response and delay estimator (226) to calculate a gain difference (Eg), a phase difference (Ep), and a timing delay difference (Ed) for each transmit chain with respect to the reference chain. The controller (232) may compare the gain difference (Eg), the phase difference (Ep), and the timing delay difference (Ed) with a gain error threshold (Tg), a phase error threshold (Tp), and a delay error threshold (Td), respectively. It may be appreciated that all thresholds may be configurable and may be defined as per design implementation. If the estimation of coefficients is required based on the comparison, the controller (232) may identify a control signal (c₄) to inform the coefficient estimator (230) for the estimation of the calibration coefficients.

In an embodiment, during the operating phase, the controller (232) may control the periodicity of the calibration by updating a timer value adaptively.

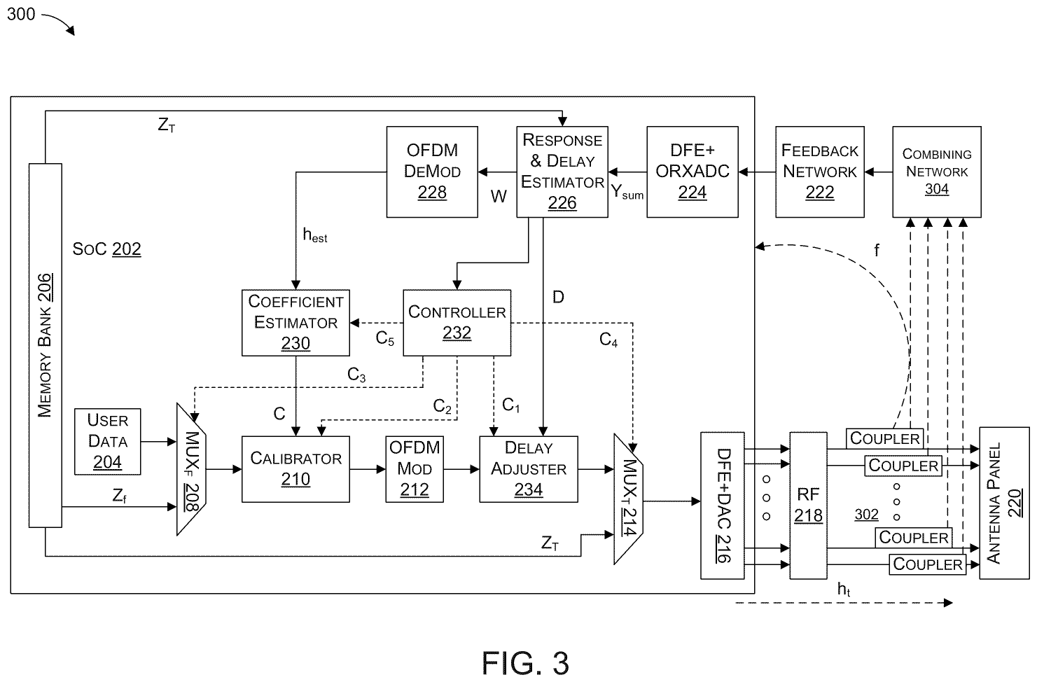

FIG. 3 illustrates an exemplary system architecture (300) for antenna calibration with no calibration port inside an antenna panel (220), in accordance with an embodiment of the present disclosure.

A person skilled in the art may understand that the various modules mentioned in FIG. 3 may be similar to the corresponding modules of FIG. 2 in their functionality and may not be described again for the sake of brevity.

With reference to FIG. 3, a coupler (302) may provide coupled output for a feedback path. In an embodiment, a combining network (304) may include a series of combiners to combine the feedback signal from each transmit antenna.

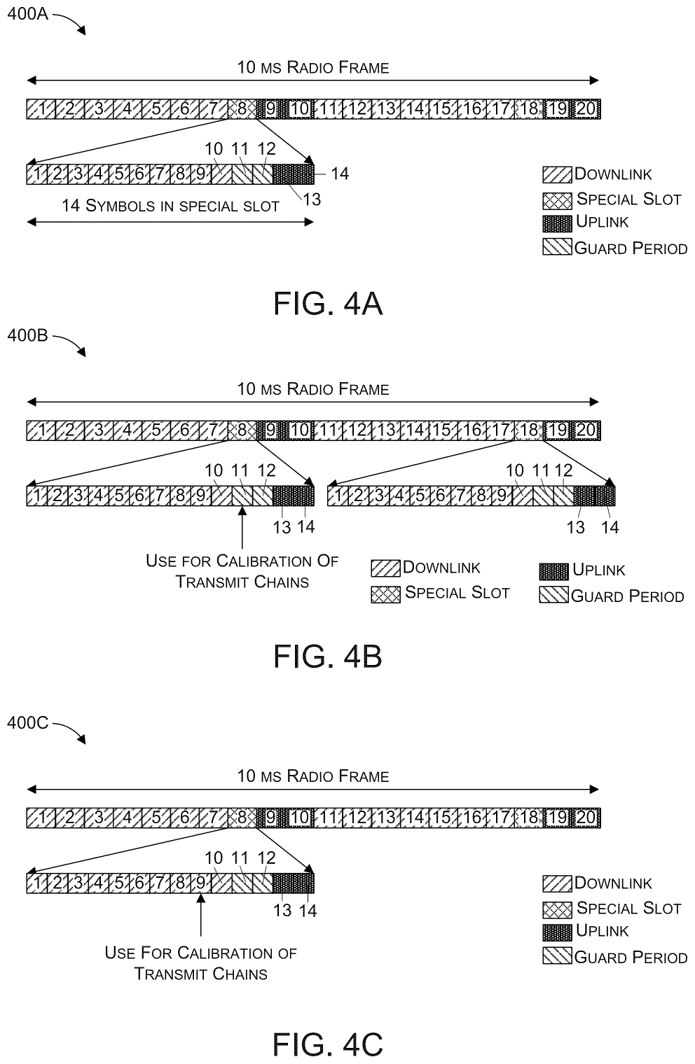

FIG. 4A illustrates an exemplary representation (400A) of a 5G New Radio (NR) Time Division Duplex (TDD) radio frame, in accordance with an embodiment of the present disclosure.

With reference to FIG. 4A, considering the 30 kHz subcarrier spacing, a 10 ms radio frame may include 20 time slots, each having 14 OFDM symbols. The downlink may occupy 14 slots, and the uplink may occupy 4 slots out of 20 slots in normal conditions. The rest of the two slots may be used as special slots. The 14 OFDM symbols in each special slot may be configured as 10 symbols for downlink, 2 symbols for the guard period, and 2 symbols for uplink. To avoid information loss, a base station utilizes the guard period of the special slots to perform the calibration operation during the operating phase.

FIG. 4B illustrates an exemplary representation (400B) for implementing calibration in a special slot with two guard periods, in accordance with an embodiment of the present disclosure.

With reference to FIG. 4B, if only two guard periods are present in one special slot, then fine-tuned calibration of the transmit chains may be implemented in a first guard period of the current special slot. In another embodiment, the fine-tuned calibration of the transmit chains may be implemented based on a request by higher layers of the base station to increase a size of the guard period to perform the calibration of transmit chains in the same special slot.

FIG. 4C illustrates an exemplary representation (400C) for implementing calibration in a special slot with four guard periods, in accordance with an embodiment of the present disclosure.

With reference to FIG. 4C, if four or more guard periods are present in one radio frame, then fine-tuned transmit chain calibration may be implemented in the first guard period of the same special slot.

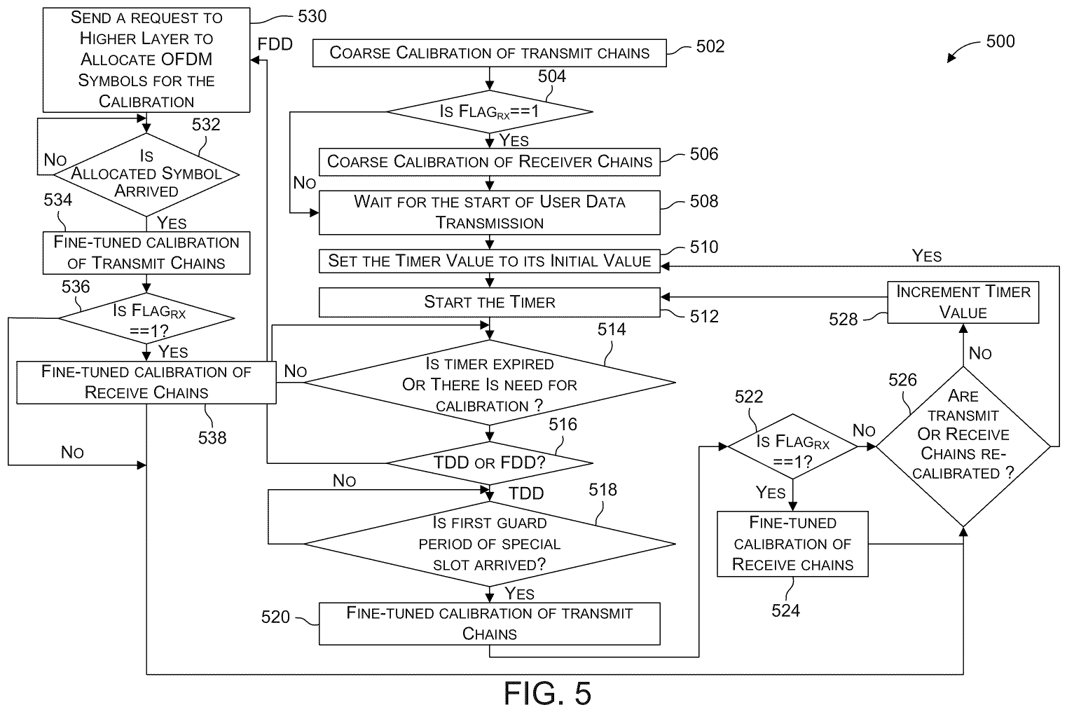

FIG. 5 illustrates a high-level flow chart of an exemplary method (500) for antenna calibration of transmit chains, in accordance with an embodiment of the present disclosure. It may be appreciated that the method (500) may be implemented by the base station, i.e. the controller (232) or the processor.

The antenna calibration of a 5G NR TDD MIMO base station may measure signal characteristics across the transmit chains, and determine the differences across the transmit chains, specifically in terms of gain, phase, and timing. Further, the antenna calibration may calibrate the transmit signals to mitigate the differences across the transmit chains. The calibration may include two phases, namely a start-up phase and an operating phase.

In the start-up phase, the calibration may be implemented during a start-up/booting of the base station. It may be considered as a coarse calibration of the base station as it equalizes the gain, phase, and timing differences across the chains, which may occur due to the system design. In the operating phase, the base station may undergo temperature variations, which may affect the characteristics of the transmit chains. Therefore, the calibration may be required during the operating phase, and thus, it may be considered as a fine-tuned calibration. The temperature variation may become slow once the base station reaches a steady state. Thus, the calibration in the operating phase may not be required frequently.

In an embodiment, the base station may be operated with a TDD radio frame to perform the calibration in a guard period during the operating phase without halting the user data transmission. This may provide leverage to the base station to maintain the spectrum efficiency of the TDD system in real-time. In another embodiment, for Frequency Division Duplex (FDD) base station, a request may be sent to the higher layer to provide the configurable number of vacated OFDM symbols for calibration. The higher layer vacates the requested number of OFDM symbols in one or more FDD radio frames and provides the frame number and OFDM symbol number to the base station to perform calibration during the operating phase.

With reference to FIG. 5, at step 502, a startup phase/coarse calibration of the transmit chains may be implemented. At 504, the method (500) may include determining a flag for performing receive chain calibration. At 506, if the base station has an option of the receive chain calibration at the start-up time, then the receive chain calibration may be executed.

At 508, if the flag is not set to 1, the method may wait for the operating phase to start the user data transmission. At 510, a value of a timer may be set to its initial value, which may be configurable. At 512, the timer may be started. In an embodiment, the operating phase/fine-tuned calibration may be implemented every time the timer expires. The operating phase/fine-tuned calibration may also be performed as requested by the higher layers or in an event of a significant change in the temperature, or a fault being identified in the reference chain.

Referring to FIG. 5, at 514, the method (500) may include determining if the timer has expired or if there is a need for calibration. The need for the calibration of the plurality of transmit chains may be based on, without limitation, an expiry of the timer, a request by the one or more higher layers, an event of a change in temperature, and a fault being identified in a given transmit chain of the plurality of transmit chains. If the timer has not expired and/or there is no need for calibration, the method (500) may include to continue to monitor the timer and/or the need for calibration. At 516, if the timer has expired or there is the need for calibration, the method (500) may include determining if the base station correspond to TDD or FDD mode.

At 518, if the base station corresponds to the TDD mode, the method (500) may include determining an arrival of a guard period of a special time slot. In an embodiment, the method (500) may include determining the arrival of a first guard period. At 520, the method (500) may perform the fine-tuned calibration of the transmit chains in the first guard period of the special time slot, if the first guard period of the special time slot has arrived. If the first guard period of the special time slot has not arrived, the method (500) continues to monitor the special time slot.

At 522, the method (500) may include determining the flag for performing receive chain calibration or transmit and receive chains re-calibration. If the flag is enabled, at 524, the method (500) may perform the fine-tuned calibration of the receive chains.

At 526, the method (500) may include determining whether re-calibration of the transmit or receive chains is performed, based on the determination of the flag, at 522. At 528, if re-calibration of the transmit or receive chains is not performed, the value of the timer may be incremented, and the method (500) may proceed to step 512. If the re-calibration of the transmit or receive chain is performed, the method (500) may proceed to step 510.

Referring to FIG. 5, at 530, if the base station corresponds to the FDD mode as determined at 516, the method (500) may include sending the request to one or more higher layers of the base station to allocate configurable number of vacated OFDM symbols for the calibration. At 532, the method (500) may include determining if the allocated OFDM symbols have arrived or not.

At 534, if the allocated OFDM symbols have arrived, the method (500) may perform the fine-tuned calibration of the transmit chains in the allocated OFDM symbols. If the allocated OFDM symbols are not arrived, the method (500) may continue to monitor the OFDM symbols.

At 536, the method (500) may include determining the flag for performing receive chain calibration or transmit and receive chains re-calibration. At 538, if the flag is enabled at 536, the method (500) may perform the fine-tuned calibration of the receive chains in the allocated OFDM symbols, and proceed to step 526. If the flag is not enabled at 536, the method (500) may proceed to step 526 . . . .

In an embodiment, the calibration periodicity may be periodic and adaptive. In periodic calibration, the timer value may be constant, i.e., the calibration may be repeated after every one or two or any fixed number of TDD radio frames. In adaptive calibration, the timer value may not be fixed and may be updated adaptively.

Adaptive calibration may mitigate the issues of the periodic calibration. Since the temperature variation is expected to be higher during the initial time of the operating phase, the timer value may be incremented by smaller values. After certain cycles, the timer value may be incremented by larger values. For example, the Fibonacci series of 1, 2, 3, 5, 8, 13, 21, 34, 55, 89, 144, 233, 377, 610 (seconds) may be used as the timer value.

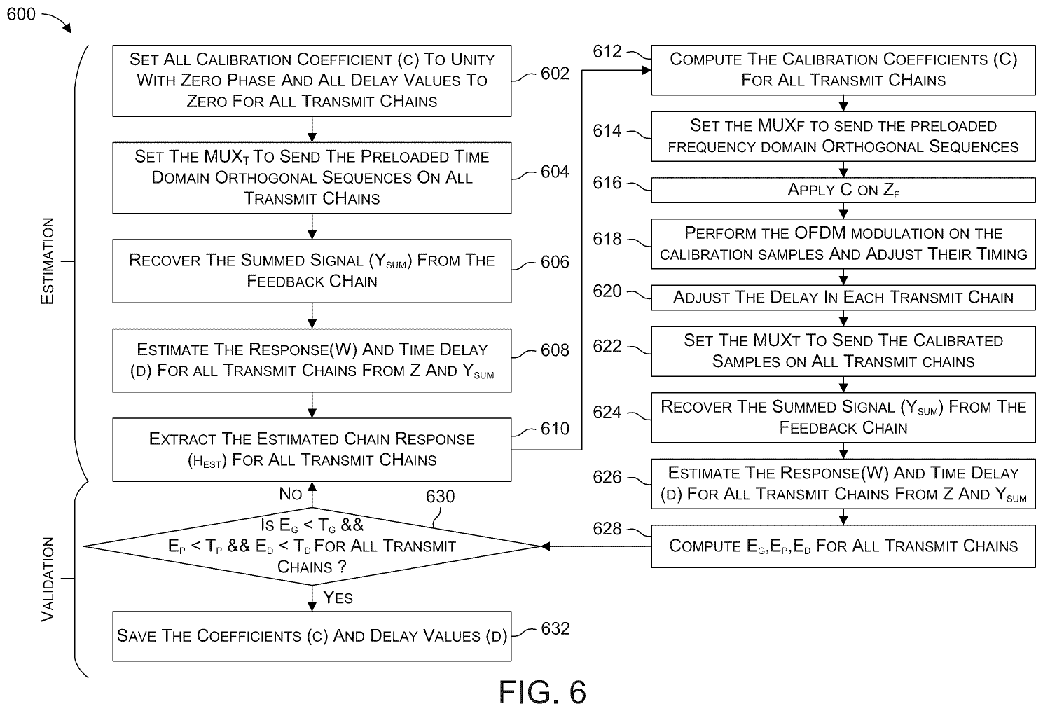

FIG. 6 illustrates a flow chart of an exemplary method (600) for coarse calibration of transmit chains in a base station, in accordance with an embodiment of the present disclosure.

With reference to FIG. 6, at 602, the method (600) may include setting all calibration coefficients to unity with zero phase and all delay values to zero in a calibrator (e.g., 210 of FIG. 2) for all transmit chains using a control signal (c1).

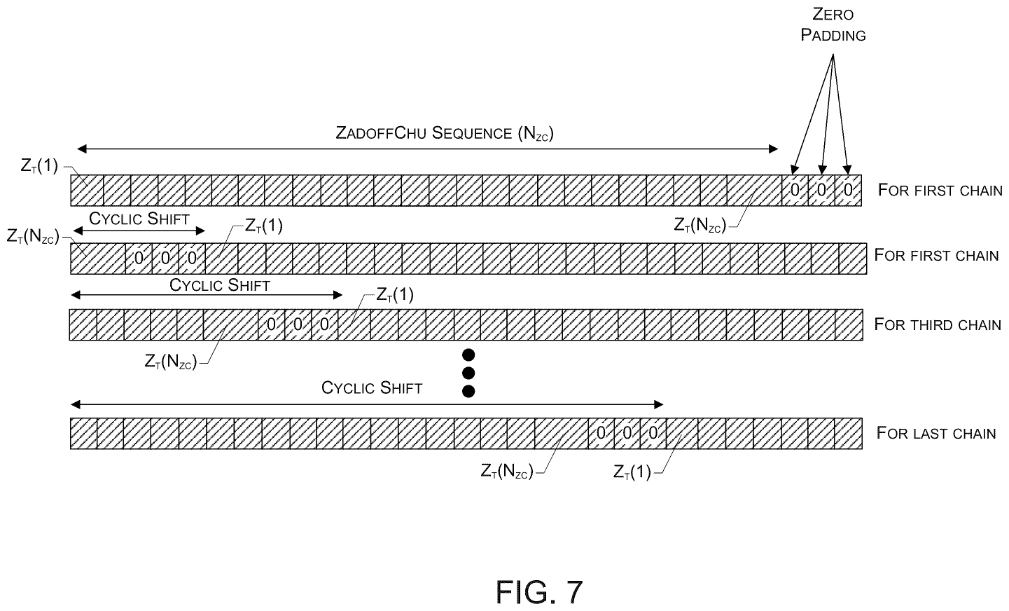

At 604, the method (600) may include setting a first multiplexer (MUX_{T}) (e.g., 214) using a control signal (c₂) to load the time-domain orthogonal sequences, for example, ZadoffChu sequences (Z_{T}) as the test sequence. The ZadoffChu sequences may be generated offline and stored in a memory. The ZadoffChu sequences may be generated for different transmit chains, as shown in FIG. 7. In an embodiment, a ZadoffChu sequence generator may be implemented in a SoC (e.g., 202) to generate the ZadoffChu sequences in real-time. The ZadoffChu sequence may include two key parameters, namely, a length of the sequence N_{ZC}, which may be an odd prime number, and a root index q=0, 1, 2, . . . , N_{ZC}−1. With these two parameters, the ZadoffChu sequence may be defined as below:

$${Z}^{q} ( n ) = {e}^{- j 2 π q \frac{n ( n + 1 )}{{N}_{ZC}}} \qquad ( 1 )$$

where n=0, 1, 2, . . . , N_{ZC}−1.

The length of the ZadoffChu sequence may be a prime number and may be configurable. For example, the ZadoffChu sequence may be the largest prime number smaller than the FFT size. Zero padding may match the sequence length to the FFT size. The original ZadoffChu sequence may be used for the reference chain. For the other chains, the test sequence may be generated by a cyclic shift of the original ZadoffChu sequence, as shown in FIG. 7. The cyclic shift may be configurable.

At 606, the ZadoffChu sequences may undergo DFE and DAC processing before feeding to the RF chains. A first summed signal (yₛᵤₘ) of all chains may be recovered or obtained from a feedback network (e.g., 222) and then processed through DFE and ORX-ADC blocks (e.g., 224).

At 608, the method (600) may include estimating a first response (W) and a first timing delay (d) of each chain by cross-correlating the first summed signal (yₛᵤₘ) with the ZadoffChu sequences (Z) by a response and delay estimator (e.g., 226).

The periodic cross-correlation of yₛᵤₘ with Z may be defined as below:

$$W ( m ) = \frac{1}{\sqrt{{N}_{ZC}}} {\sum }_{n = 0}^{{N}_{Z C} - 1} {y}_{s u m} ( n ) Z * ( ( n - m ) mod {N}_{Z C} ) \qquad ( 2 )$$

where “*” is a complex conjugate, and “mod” is a modulus operator.

At 610, the method (600) may include extracting the chain responses from the first response (W) and passing them through a OFDM demodulator (e.g., 228) to get the chain responses (hₑₛₜ).

At 612, the method (600) may include informing a coefficient estimator (e.g., 230) to estimate the calibration coefficients (C) using a control signal (4) for each transmit chain in order to mitigate the relative gain, phase, and timing differences with respect to the reference chain.

The coefficients for each chain may be estimated from the chain responses (hₑₛₜ) to mitigate the gain and phase differences. The time delay differences may be mitigated using a time-shift property of a Fourier transform, i.e., a shift in time corresponds to a phase rotation in the frequency domain. The estimated calibration coefficients may be loaded into the calibrator (e.g., 210) using the control signal (c₁).

At 614, the method (600) may include setting a second multiplexer (MUX_{F}) (e.g., 208) using a control signal (c₃) to load the frequency-domain orthogonal sequences, for example, ZadoffChu sequences (Z_{F}). The Z_{F} may be generated by considering the FFT of the Z_{T}. At 616, the calibration coefficients (C) may be applied on the ZadoffChu sequences (ZF) to obtain calibrated sequences. At 618, the calibrated sequences may be passed through the OFDM modulator (e.g., 212) and OFDM modulation may be performed to the calibrated sequences. The timing of the calibrated sequences may be adjusted using the delay adjuster (e.g., 234).

At 620, the method (600) may include adjusting or controlling the first time delay in each transmit chain. At 622, the method (600) may include setting the MUX_{T} (214) using a control signal (c₂) to send the calibrated sequences on the transmit chains. At 624, a second summed signal (yₛᵤₘ) of all chains may be recovered or obtained from the feedback network (e.g., 222) and then processed through DFE and ORX-ADC blocks (224). At 626, a second response (W) and a second timing delay (d) of each chain may be estimated by cross-correlating the second summed signal (y′sum) with the ZadoffChu sequences (Z) by the response and delay estimator (e.g., 226).

At 628, the method (600) may include calculating E_{g}, Eₚ, and E_{d} for each chain with respect to the reference chain and comparing E_{g}, Eₚ, and E_{d} with T_{g}, Tₚ, and T_{d}, respectively. At 630, the method (600) may include determining if E_{g}<T_{g}, Eₚ<Tₚ, and E_{d}<T_{d} are satisfied. If not satisfied, the method (600) may repeat the steps 610 to 628 with different cyclic shift and/or root index of the ZadoffChu sequence. At 632, if E_{g}<T_{g}, Eₚ<Tₚ, and E_{d}<T_{d} are satisfied, the current coefficients and the delay values may be saved in a database associated with the base station.

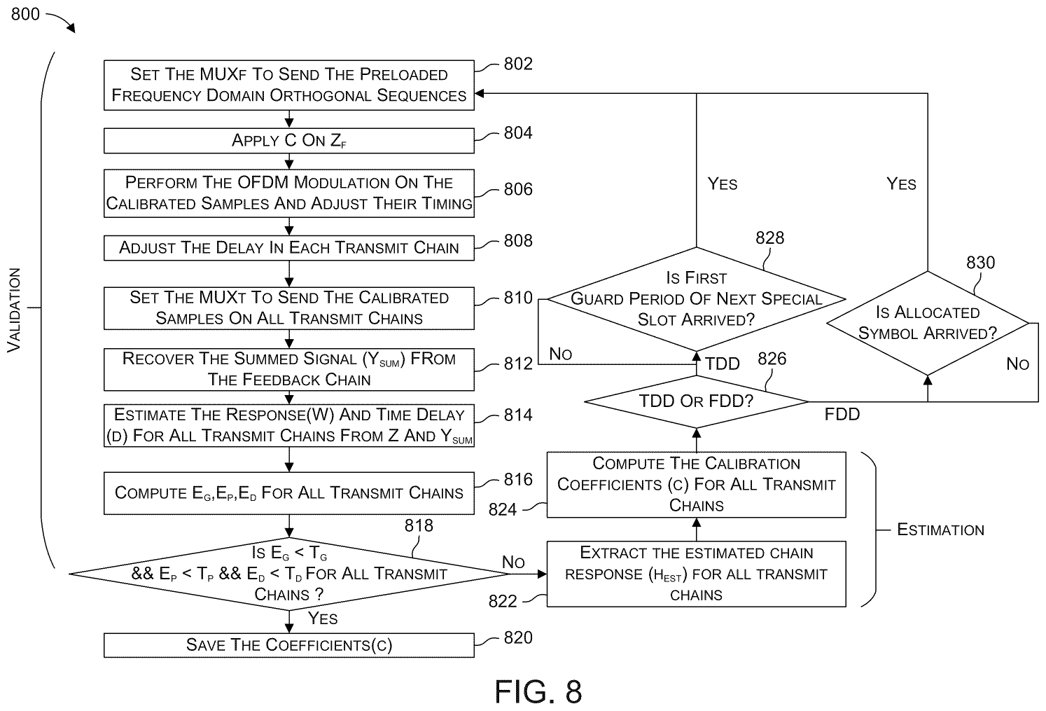

FIG. 8 illustrates a flow chart of an exemplary method (800) for implementing fine-tuned calibration of transmit chains during an operating phase of a base station, in accordance with an embodiment of the present disclosure.

With respect to FIG. 8, at 802, the method (800) may include setting a MUX_{F} (208) using a control signal (c₃) to load the frequency-domain ZadoffChu sequences (Z_{F}). The Z_{F} may be generated by taking the FFT of the Z_{T}. At 804, the method (800) may include applying the calibration coefficients (C) on Z_{F} to obtain calibrated sequences. At 806, the method (800) may include passing the calibrated sequences through an OFDM modulator (212). OFDM modulation may be performed on the calibrated sequences and the timing of the calibrated sequences may be adjusted.

At 808, the method (800) may include adjusting or controlling a delay in each transmit chain using a delay adjuster (234). At 810, the method (800) may include setting a MUX_{T} (214) using a control signal (c₂) to send the calibrated sequences on the transmit chains. At 812, the method (800) may include recovering or obtaining the summed output (yₛᵤₘ) of all chains from a feedback network (222) and processing the summed output (yₛᵤₘ) through DFE and ORX-ADC blocks (224).

At 814, the method (800) may include estimating the response (W) and timing delay (d) of each chain by cross-correlating the yₛᵤₘ with Z by a response and delay estimator (226). At 816, the method (800) may include calculating E_{g}, Eₚ, and E_{d} for each chain with respect to the reference chain and comparing them with T_{g}, Tₚ, and T_{d}, respectively.

At 818, the method (800) may include determining if E_{g}<T_{g}, Eₚ<Tₚ, and E_{d}<T_{d} are satisfied. At 820, the method (800) may include saving the current coefficients in a database associated with the base station, if the E_{g}<T_{g}, Eₚ<Tₚ, and E_{d}<T_{d} are satisfied. At 822, if E_{g}<T_{g}, Eₚ<Tₚ, and E_{d}<T_{d} are not satisfied, the method (800) may include extracting the chain responses from the estimated response (W) and passing them through a OFDM demodulator (228) to get the chain responses (hₑₛₜ).

At 824, the method (800) may include informing a coefficient estimator (230) to estimate the calibration coefficients (C) using the control signal (c₄) for each transmit chain in order to mitigate the relative gain, phase, and timing differences with respect to the reference chain.

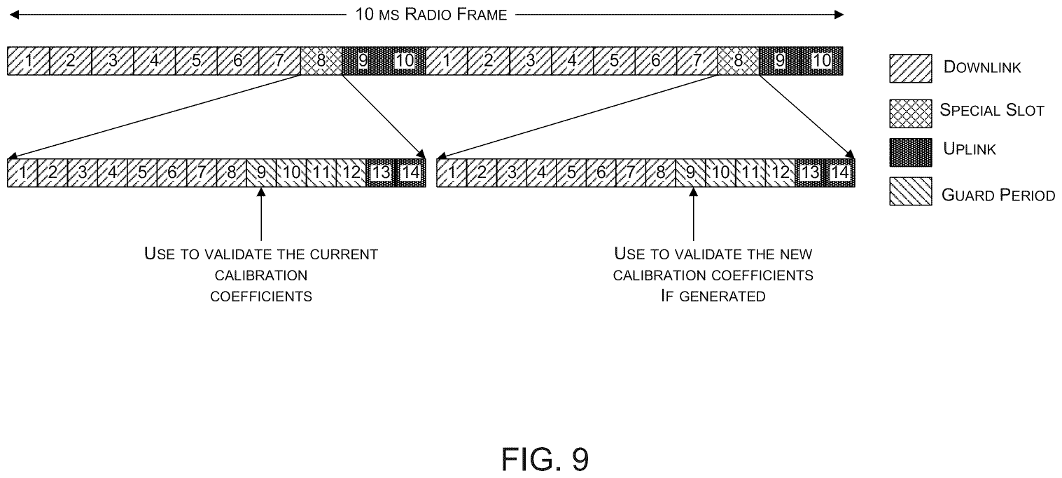

At 826, the method (800) may include determining if the base station corresponds to TDD or FDD mode. At 828, if the base station corresponds to the TDD mode, the method (800) may include determining the arrival of the first guard period of the next special slot to validate the new estimated coefficients or updated coefficients, as shown in FIG. 9. FIG. 9 depicts fine-tuned calibration in two special slots. If the first guard period of the next special slot has arrived, the new estimated calibration coefficients may be loaded into a calibrator (210) using the control signal (c₁) and the steps 802 to 814 may be repeated. If the first guard period of the next special slot has not arrived, the method (800) may continue to monitor the arrival of the first guard period of the next special slot.

Alternatively, at 830, if the base station corresponds to the FDD mode, the method (800) may include determining the arrival of the specific OFDM symbol allocated by the higher layer in the base station for performing the fine-tuned calibration of the transmit chains. If the specific OFDM symbol has arrived, the new estimated calibration coefficients may be loaded into the calibrator (210) using the control signal (c₁) and the steps 802 to 814 may be repeated. If the specific OFDM symbol has not arrived, the method (800) may continue to monitor the arrival of the specific OFDM symbol.

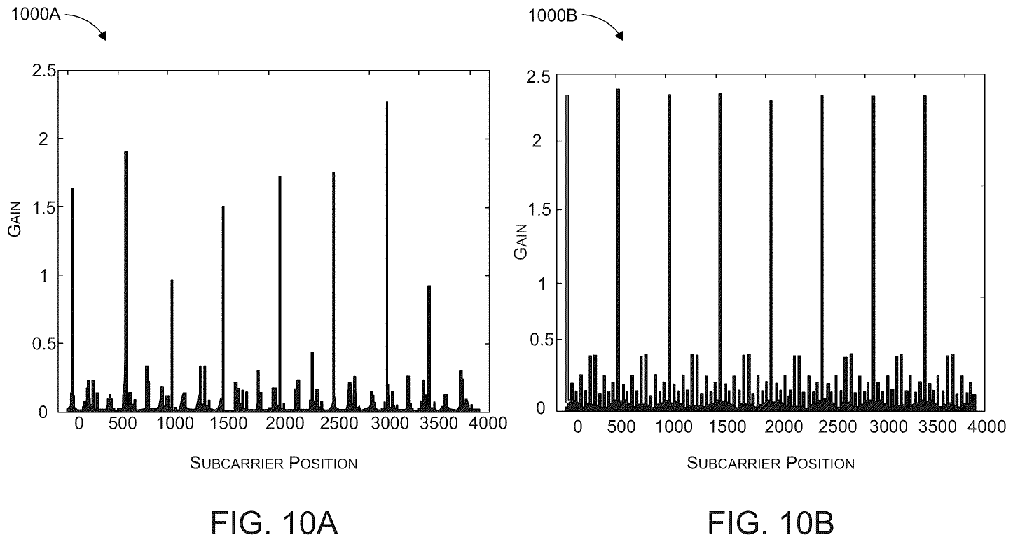

FIGS. 10A and 10B illustrate exemplary representations (1000A, 1000B) of a gain plot of an estimated value of transmit chain responses before calibration and after calibration, respectively, in accordance with an embodiment of the present disclosure.

With respect to FIG. 10A, the gain plot of the response (W (m)) for 8 transmit chains is depicted. It may be observed that the 8 peaks present in the graph represent the gain response of the 8 transmit chains. Ideally, these responses may appear at the cyclic shift positions. For example, considering the cyclic shift of 500, the 8 chain responses may appear ideally at 1^{st}, 501^{st}, 1001^{st}, 1501^{st}, . . . , 3501^{st} subcarrier positions. However, they are deviated from their expected positions and appear at 69^{th}, 582^{nd}, 1055^{th}, 1597^{th}, . . . , 3550^{th} subcarrier positions which may be observed in FIG. 10A. The difference between the estimated position and the expected position represents the timing delay (d) of each transmit chain.

With respect to FIG. 10B, the gain plot of the chain responses (W(m)) for 8 transmit chains after calibration is depicted. It may be observed that the 8 peaks present in the graph have relatively the same gain response. Further, these responses relatively appear at the cyclic shift positions. Thus, the gain, phase, and timing delay of all transmit chains are relatively the same after applying the estimated calibration coefficients.

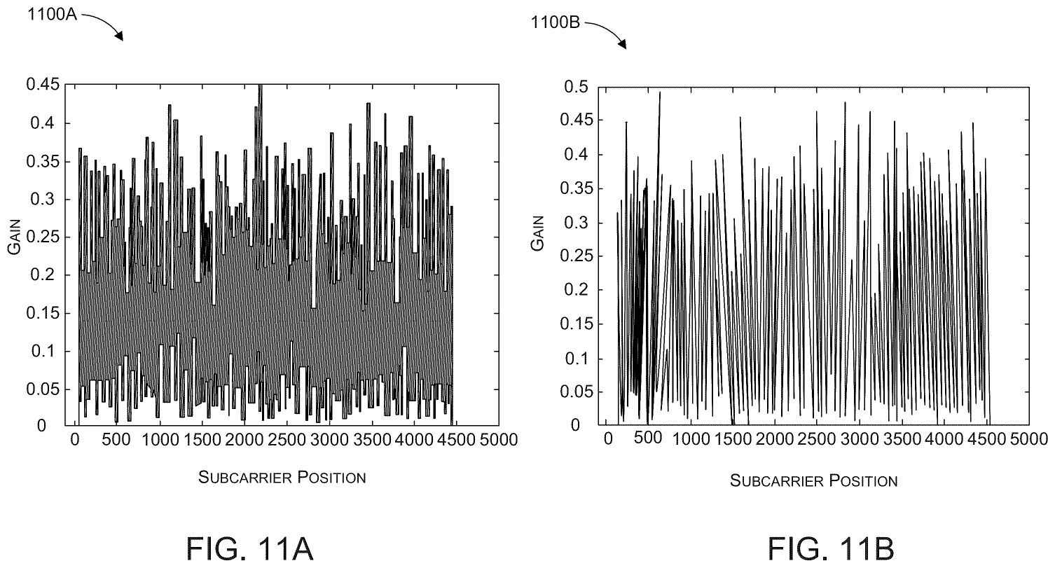

FIGS. 11A and 11B illustrate exemplary representations (1100A, 1100B) of a gain plot of signal at different antenna ports without antenna calibration, in accordance with an embodiment of the present disclosure.

Considering a 5G NR TDD MIMO base station equipped with 8 transceivers, all 8 chains are excited with the same random signal. The gain plot of the signals appears at the 3^{rd} and 8^{th} RF antenna ports without antenna calibration are shown in FIGS. 11A and 11B, respectively.

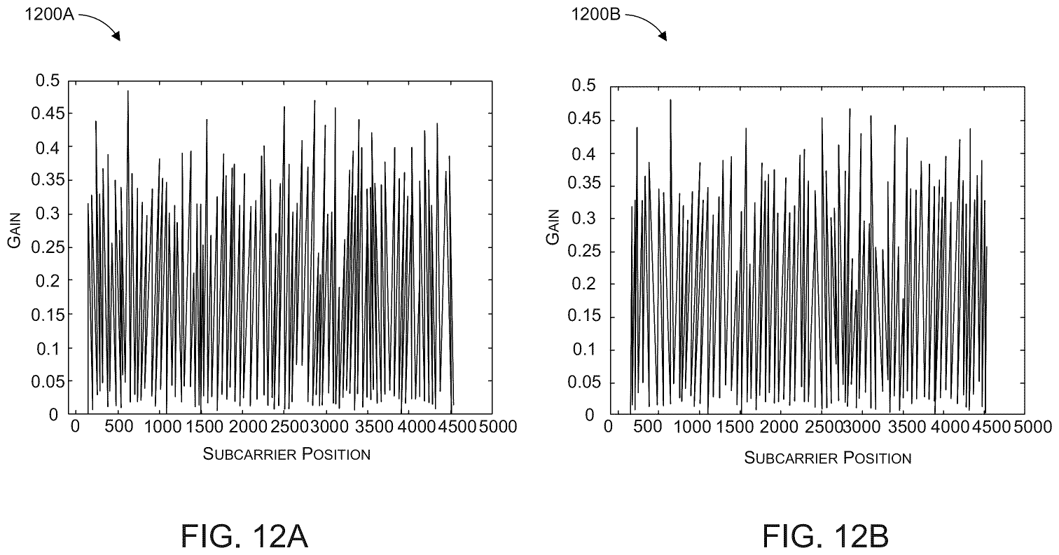

FIGS. 12A and 12B illustrate exemplary representations (1200A, 1200B) of a gain plot of signal at different antenna ports with antenna calibration, in accordance with an embodiment of the present disclosure.

The gain plot of the signals appears at the 3^{rd} and 8^{th} RF antenna ports with antenna calibration as shown in FIGS. 12A and 12B, respectively.

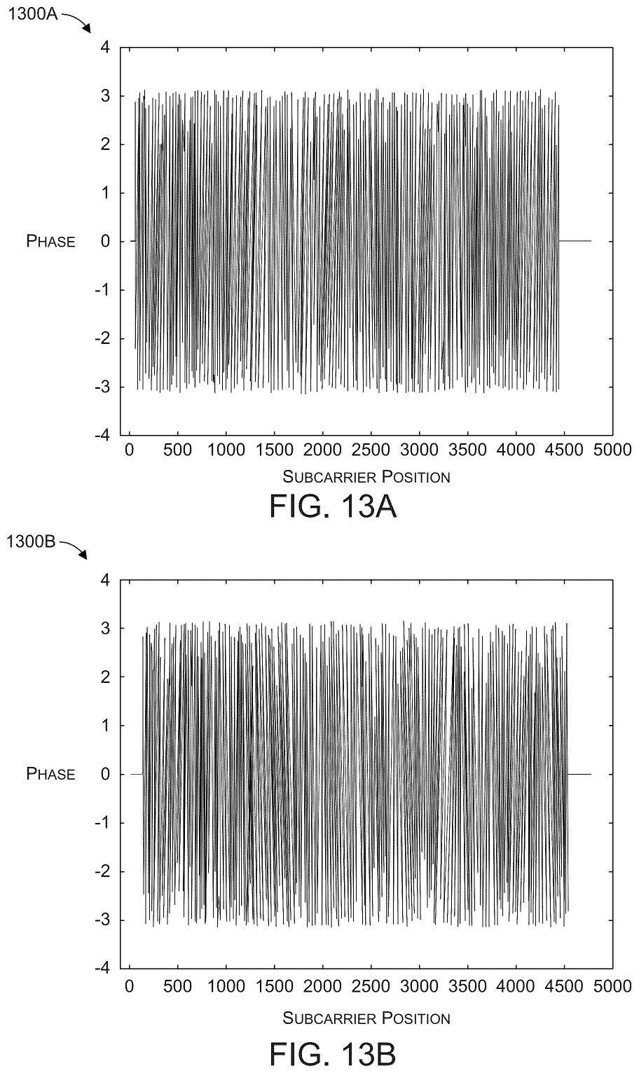

FIGS. 13A and 13B illustrate exemplary representations (1300A, 1300B) of a phase plot of signal at different antenna ports without antenna calibration, in accordance with an embodiment of the present disclosure.

The phase plot of the signals appears at the 3^{rd} and 8^{th} RF antenna ports without antenna calibration are shown in FIGS. 13A and 13B, respectively. It may be evident from these results that in the absence of antenna calibration, the responses of both transceivers are not identical, and a similar mismatch may also be observed with the remaining chains.

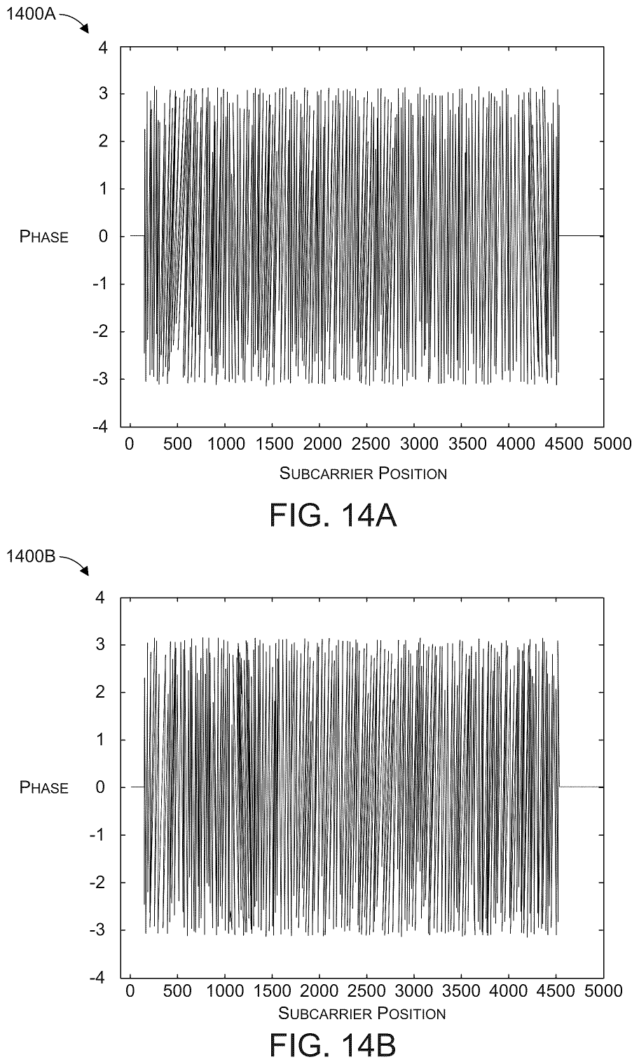

FIGS. 14A and 14B illustrate exemplary representations (1400A, 1400B) of a phase plot of signal at different antenna ports with antenna calibration, in accordance with an embodiment of the present disclosure.

The phase plot of the signals appears at the 3^{rd} and 8^{th} RF antenna ports with antenna calibration as shown in FIGS. 14A and 14B, respectively. It may be easily observed that the gain and phase of the 3^{rd} and 8^{th} transceivers becomes equivalent and similar behaviour may also be seen in the remaining chains. It may be concluded that the system and method for the antenna calibration of transmit chains of the 5G NR TDD MIMO base station may be used to mitigate the gain, phase, and timing differences across the transmit chains.

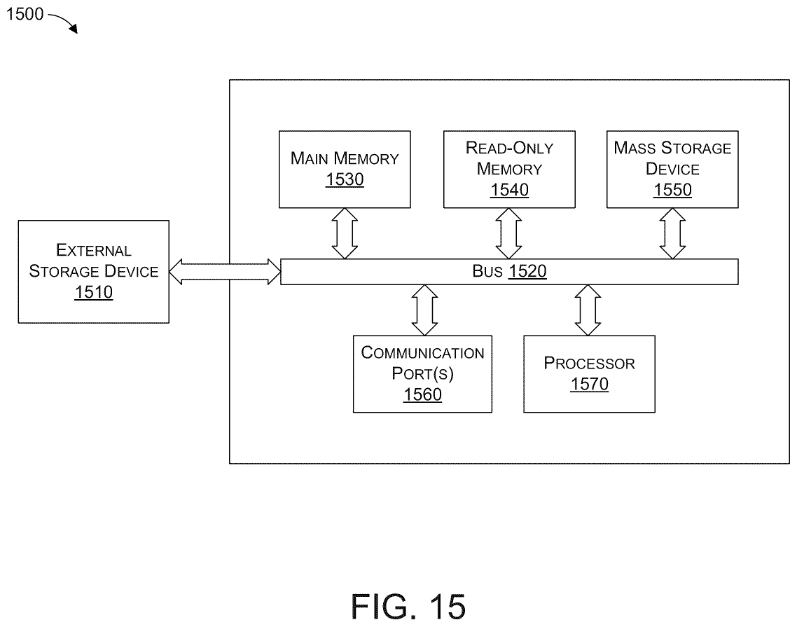

FIG. 15 illustrates an exemplary computer system (1500) in which or with which embodiments of the present disclosure may be implemented.

The blocks of the flow diagrams shown in FIGS. 5, 6, and 8 have been arranged in a generally sequential manner for ease of explanation; however, it is to be understood that this arrangement is merely exemplary, and it should be recognized that the processing associated with methods (500, 600, 800) may occur in a different order (for example, where at least some of the processing associated with the blocks is performed in parallel and/or in an event-driven manner). Further, it may be appreciated that the steps shown in FIGS. 5, 6, and 8 are merely illustrative. Other suitable steps may be used for the same, if desired. Moreover, the steps of the method (500, 600, 800) may be performed in any order and may include additional steps.

The methods and techniques described herein may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 15, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 15 illustrates an exemplary computer system (1500) in which or with which embodiments of the present disclosure may be utilized. The computer system (1500) may be implemented as or within the base station described in accordance with embodiments of the present disclosure.

As depicted in FIG. 15, the computer system (1500) may include an external storage device (1510), a bus (1520), a main memory (1530), a read-only memory (1540), a mass storage device (1550), communication port(s) (1560), and a processor (1570). A person skilled in the art will appreciate that the computer system (1500) may include more than one processor (1570) and communication ports (1560). The processor (1570) may include various modules associated with embodiments of the present disclosure. The communication port(s) (1560) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (1560) may be chosen depending on a network, such a Local Area Network (LAN), Wide Area Network (WAN), or any network to which the computer system (1500) connects.

In an embodiment, the main memory (1530) may be Random Access Memory (RAM), or any other dynamic storage device commonly known in the art. The read-only memory (1540) may be any static storage device(s) e.g., but not limited to, a Programmable Read Only Memory (PROM) chips for storing static information e.g., start-up or basic input output system (BIOS) instructions for the processor (1570). The mass storage device (1550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (1520) communicatively couples the processor (1570) with the other memory, storage, and communication blocks. The bus (1520) may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (1570) to the computer system (1500).

In another embodiment, operator and administrative interfaces, e.g., a display, keyboard, and a cursor control device, may also be coupled to the bus (1520) to support direct operator interaction with the computer system (1500). Other operator and administrative interfaces may be provided through network connections connected through the communication port(s) (1560). Components described above are meant only to exemplify various possibilities. In no way should the aforementioned exemplary computer system (1500) limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure facilitates calibration of Radio Frequency (RF) paths at a start-up phase and during an operating phase of a fifth-generation (5G) new radio (NR) base station (BS) adaptively without impacting user data transmission.

The present disclosure facilitates calibration of RF paths during run-time of a communication apparatus, i.e., calibration of RF transmission path in between data transmission without affecting a data transmission rate.

The present disclosure enables handling of variation in temperature and processing of delay between multiple RF transmission paths.

The present disclosure facilitates adaptive calibration of RF transmit chains in a Multiple-Input Multiple-Output (MIMO) communication apparatus which also utilizes resources optimally and effectively.

We claim:

1. A method for calibration of transmit chains in a start phase of a base station, the method comprising:
setting, by a controller, delay values to zero and calibration coefficients to unity with zero phase for each of a plurality of transmit chains;
setting, by the controller, a first multiplexer to send orthogonal sequences on each of the plurality of transmit chains;
obtaining, by the controller, a first summed signal of the plurality of transmit chains;
estimating, by the controller, a first response and a first time delay for each of the plurality of transmit chains by cross-correlating the first summed signal with an orthogonal sequence; and
computing, by the controller, calibration coefficients and delay values for each of the plurality of transmit chains based on the estimated first response to mitigate relative gain and phase differences with respect to a given transmit chain.

2. The method of claim 1, further comprising:
setting, by the controller, a second multiplexer to send frequency domain equivalent of the orthogonal sequences on each of the plurality of transmit chains;
applying, by the controller, the computed calibration coefficients on the frequency domain equivalent of the orthogonal sequences to obtain calibrated sequences;
performing, by the controller, Orthogonal Frequency-Division Multiplexing (OFDM) modulation on the calibrated sequences; and
controlling, by the controller, the first time delay in each of the plurality of transmit chains by adjusting a timing of the calibrated sequences.

3. The method of claim 2, further comprising:
setting, by the controller, the first multiplexer to send the calibrated sequences on each of the plurality of transmit chains;
obtaining, by the controller, a second summed signal of the plurality of transmit chains;
estimating, by the controller, a second response and a second time delay for each of the plurality of transmit chains;
computing, by the controller, a gain difference, a phase difference, and a timing delay difference of each of the plurality of transmit chains with respect to the given transmit chain, based on the estimation; and
comparing, by the controller, the gain difference, the phase difference, and the timing delay difference of each of the plurality of transmit chains with a gain error threshold, a phase error threshold, and a delay error threshold, respectively.

4. The method of claim 3, wherein responsive to at least one of the gain difference, the phase difference, and the timing delay difference of each of the plurality of transmit chains being less than the gain error threshold, the phase error threshold, and the delay error threshold, respectively, the method further comprises storing, by the controller, the computed calibration coefficients and the computed delay values in a database associated with the base station to perform the calibration of the plurality of transmit chains.

5. The method of claim 3, wherein responsive to at least one of the gain difference, the phase difference, and the timing delay difference of each of the plurality of transmit chains being greater than the gain error threshold, the phase error threshold, and the delay error threshold, respectively, the method further comprises computing, by the controller, updated calibration coefficients and/or updated delay values for each of the plurality of transmit chains based on the estimated first response to mitigate the gain difference, the phase difference, or the timing delay difference with respect to the given transmit chain.

6. A method for calibration of transmit chains in a base station, the method comprising:
determining, by a controller, that user data transmission is initiated in an operating phase of the base station;
determining, by the controller, a need for calibration of a plurality of transmit chains in the base station;
in response to the determination, detecting, by the controller, an arrival of at least one of: a guard period of a special time slot in a Time-Division Duplex (TDD) radio frame, or an Orthogonal Frequency-Division Multiplexing (OFDM) symbol allocated by one or more higher layers in a Frequency Division Duplex (FDD) radio frame; and
performing, by the controller, fine-tuned calibration of each of the plurality of transmit chains based on the detection.

7. The method of claim 6, wherein determining, by the controller, the need for the calibration of the plurality of transmit chains is based on at least one of: an expiry of a timer, a request by the one or more higher layers, an event of a change in temperature, and a fault being identified in a given transmit chain of the plurality of transmit chains.

8. The method of claim 6, wherein performing, by the controller, the fine-tuned calibration of each of the plurality of transmit chains comprises:
for each of the plurality of transmit chains:
setting, by the controller, a first multiplexer to send orthogonal sequences on the plurality of transmit chains;
applying, by the controller, calibration coefficients on the orthogonal sequences to obtain calibrated sequences, wherein the calibration coefficients are computed during a start phase of the base station or during earlier stages of the operating phase;
performing, by the controller, OFDM modulation on the calibrated sequences; and
controlling, by the controller, a delay in each of the plurality of transmit chains by adjusting a timing of the calibrated sequences.

9. The method of claim 8, further comprising:
setting, by the controller, a second multiplexer to send the calibrated sequences on the plurality of transmit chains;
obtaining, by the controller, a summed signal of the plurality of transmit chains;
estimating, by the controller, a response and a time delay of each of the plurality of transmit chains by cross-correlating the summed signal of the plurality of transmit chains with an orthogonal sequence;
computing, by the controller, a gain difference, a phase difference, and a timing delay difference of each of the plurality of transmit chains with respect to a given transmit chain, based on the estimation; and
comparing, by the controller, the gain difference, the phase difference, and the timing delay difference of each of the plurality of transmit chains with a gain error threshold, a phase error threshold, and a delay error threshold, respectively.

10. The method of claim 9, wherein responsive to at least one of the gain difference, the phase difference, and the timing delay difference of each of the plurality of transmit chains being less than the gain error threshold, the phase error threshold, and the delay error threshold, respectively, the method further comprises storing, by the controller, the calibration coefficients in a database associated with the base station to perform the fine-tuned calibration of each of the plurality of transmit chains.

11. The method of claim 9, wherein responsive to at least one of the gain difference, the phase difference, and the timing delay difference of each of the plurality of transmit chains being greater than the gain error threshold, the phase error threshold, and the delay error threshold, respectively, the method further comprises:
computing, by the controller, updated calibration coefficients for each of the plurality of transmit chains based on the estimated response;
detecting, by the controller, an arrival of at least one of: a guard period of a consecutive special time slot in the TDD radio frame, or another OFDM symbol allocated by the one or more higher layers in the FDD radio frame; and
performing, by the controller, the fine-tuned calibration of each of the plurality of transmit chains based on the detection.

12. The method of claim 6, wherein the guard period corresponds to a first guard period of the special time slot.

13. The method of claim 7, wherein the fine-tuned calibration comprises at least an adaptive calibration, and wherein for the adaptive calibration, the method further comprises adaptively controlling, by the controller, a value of the timer for performing the fine-tuned calibration of the plurality of transmit chains.

14. A base station for calibration of transmit chains in an operating phase, comprising:
a controller associated with a processor; and
a memory operatively coupled to the processor, wherein the memory comprises processor-executable instructions which, when executed by the processor, cause the controller to:
determine that user data transmission is initiated in the operating phase of the base station;
determine a need for calibration of a plurality of transmit chains in the base station;
in response to the determination, detect an arrival of at least one of: a guard period of a special time slot in a Time-Division Duplex (TDD) radio frame, and an Orthogonal Frequency-Division Multiplexing (OFDM) symbol allocated by one or more higher layers in a Frequency Division Duplex (FDD) radio frame; and
perform fine-tuned calibration of each of the plurality of transmit chains based on the detection.

15. The base station of claim 14, wherein the processor is to perform the fine-tuned calibration of each of the plurality of transmit chains by being configured to:
combine signals of each of the plurality of transmit chains; and
estimate a response and a time delay for each of the plurality of transmit chains.
